(19) United States
(12) Patent Application Publication
(10) Pub. No.: US 2002/0082857 A1
(43) Pub. Date: Jun. 27, 2002

(54) Method and apparatus for providing an online document and input form creation and storage system

(76) Inventors: Val Skordin, San Francisco, CA (US); Keith Lightbody, Los Gatos, CA (US); Debbie Thompson, Monte Sereno, CA (US)

Correspondence Address: OPPENHEIMER WOLFF & DONNELLY, P. O. BOX 10356, PALO ALTO, CA, 94303, US

(21) Appl. No.: 09/948,295

(22) Filed: Sep. 6, 2001

Related U.S. Application Data
(60) Provisional application No. 60/231,055, filed on Sep. 8, 2000.

(51) Int. Cl. G06F 17/60

(52) U.S. Cl. 705/1; 707/500

(57) ABSTRACT

A method and apparatus are afforded for providing an online document and input form creation and storage system. Online tools enabling users to develop documents including fixed data and variable data and a worksheet relating to the variable data are provided. A library in which documents developed by the users are stored, the library being remotely accessible. A particular user is allowed to select a document from the library. A worksheet corresponding to the document selected is than provided and the user is allowed to input variable data into the worksheet. The user input data from the worksheet is then merged with the fixed data from the document selected to develop a document file and the document file is used to display to the user a completed document including the merged data.

This application claims the benefit of U.S. Provisional Application No. 60/231,055 filed Sep. 8, 2000 and entitled Method and apparatus for providing business-to-business products and services in an integrated web-based environment, the entire content of such Application being expressly incorporated herein by reference.

### TECHNICAL FIELD

The present invention relates generally to document database systems, and more particularly to a method and apparatus for providing an online user-designed input form and document system.

### BACKGROUND ART

The completion of documents is an important part of any business process, often being the final or one of many key steps in completing a business process. Furthermore, documents may be a significant part of beginning a business process. For example, the process of buying a house cannot begin until a document to submit an offer on the house has been completed.

The design of documents for the particular business process at hand, whether it be real estate as in the above example, or a bankruptcy proceeding or the sale of a company, changes depending on the business process. Various products exist for the creation of documents. For example, Adobe software has a product entitled Acrobat (TM) that allows for the creation of documents that can be distributed across the web in the file format known as PDF. The user creates the document using the software application installed on the user's personal computer.

As another example, Caere software offers an application that supports document scanning and creates data input areas in the scanned document file, the result of the scanning process using their software. The software application is a stand alone application that runs on a computer of the user.

Although applications exist for document creation, they require memory space on the client side, the user. The number of documents that may be involved in a business process can utilize a great deal of space on a computer. Further, it may not be convenient to utilize a software application on a personal computer to create documents that are distributed via the web. Accordingly, a method is needed for providing document creation and distribution online without the need for client side software requirements.

### SUMMARY OF THE INVENTION

Accordingly, it is an object of the present invention to provide a document system that allows for the design of pre-filled documents and the creation of new documents via user input corresponding to variable elements.

It is another object of the invention to allow a user to conduct business transactions via an online business application providing user-specified design of forms and documents meeting the process requirements of the particular business.

Still another object of the present invention is to provide a true paperless online electronic library that replaces existing paper forms.

It is yet another object of the invention to provide convenient access to documents conforming to business processes.

Briefly, a preferred embodiment of the present invention is a method and apparatus for providing an online document and input form creation and storage system. Online tools enabling users to develop documents including fixed data and variable data and a worksheet relating to the variable data are provided. A library in which documents developed by the users are stored, the library being remotely accessible.

A particular user is allowed to select a document from the library. A worksheet corresponding to the document selected is then provided and the user is allowed to input variable data into the worksheet. The user input data from the worksheet is then merged with the fixed data from the document selected to develop a document file and the document file is used to display to the user a completed document including the merged data.

An advantage of the present invention is that it provides online access to various documents.

Another advantage of the present invention is that it allows for the completion of forms required by particular businesses.

A further advantage of the present invention is that documents may reflect the correct status of a business process by being linked to specific business statuses.

Yet another advantage of the present invention is that documents may be utilized inter-dependently, so that user input triggers related events and processes.

Still another advantage is that document data can be maintained and data exchange between documents can be supported.

A still further advantage of the invention is that input data from various devices can be supported.

The foregoing and other objects, features and advantages of the invention will be apparent from the following detailed description of the preferred embodiment(s) which make(s) reference to (the several figures of) the drawing.

### BRIEF DESCRIPTION OF THE DRAWINGS

FIG. 1 is a flowchart illustrating a process for providing an online user designed input form and document system in accordance with the present invention;

FIG. 2 is a flowchart illustrating document processing in a document catalog in accordance with the present invention;

FIG. 3 is a flowchart illustrating worksheet generation in accordance with the present invention;

FIG. 4 is a flowchart illustrating user input into a worksheet in accordance with the present invention;

FIG. 5 is a flowchart illustrating the merger of worksheet data with document data for display of the resulting file in accordance with the present invention;

FIG. 6 is a flowchart illustrating a business environment in which a document is utilized;

FIG. 7 is a flowchart illustrating a connection between a document within a business process and the manner in which it is associated with that process;

FIG. 8 is a schematic diagram illustrating a possible layout of a worksheet in accordance with the present invention;

FIG. 9 is a flowchart illustrating two levels of catalogs utilized by the application to distribute application components to the user;

FIG. 10 is a flowchart illustrating the contact system in accordance with the present invention;

FIG. 11 is a flowchart illustrating a user messaging system in accordance with the present invention;

FIG. 12 is a flowchart illustrating the process utilized by the user-recipient to retrieve messages sent by the user-sender; and

FIG. 13 is a flowchart illustrating a calendar system in accordance with the present invention.

### BEST MODE FOR CARRYING OUT THE INVENTION

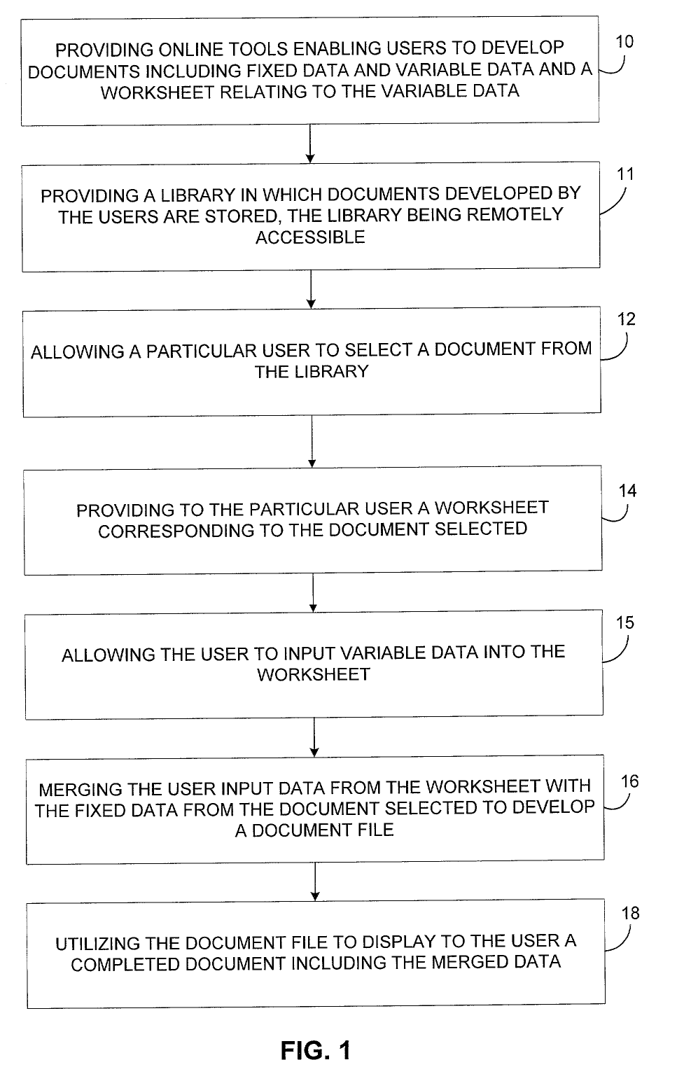

Referring now to the drawings, a preferred embodiment of the present invention is illustrated via a flowchart in FIG. 1. Online tools are provided enabling users to develop documents including fixed data and variable data and a worksheet relating to the variable data (Block 10) and a library is provided in which documents developed by the users are stored, the library being remotely accessible (Block 11). A particular user is allowed to select a document from the library (Block 12). The library may include document titles organized according to a category, a type, or an HTML template file name. The document may include non-variable data. Furthermore, the particular user may be allowed to add a new document to the library. Optionally, user authorization may be required in order to allow the user to add the new document to the library. In addition, user authorization may be required in order for the user to be allowed to select the document from the document library. A worksheet corresponding to the document selected is provided to the user (Block 14) and the user is allowed to input variable data into the worksheet (Block 15). The user may request a corresponding worksheet after selecting the document. The worksheet may include input fields for the input of variable elements of the document selected. The user input may come from a wireless device, a handheld device, a computing device, or a telephonic device. The data input by the user is merged with the fixed data from the document selected to develop a document file (Block 16) and the document file is utilized to display to the user a completed document including the merged data (Block 18). The document file including the merged data may be an HTML file. Further, the file may be displayed in a format specified by the user.

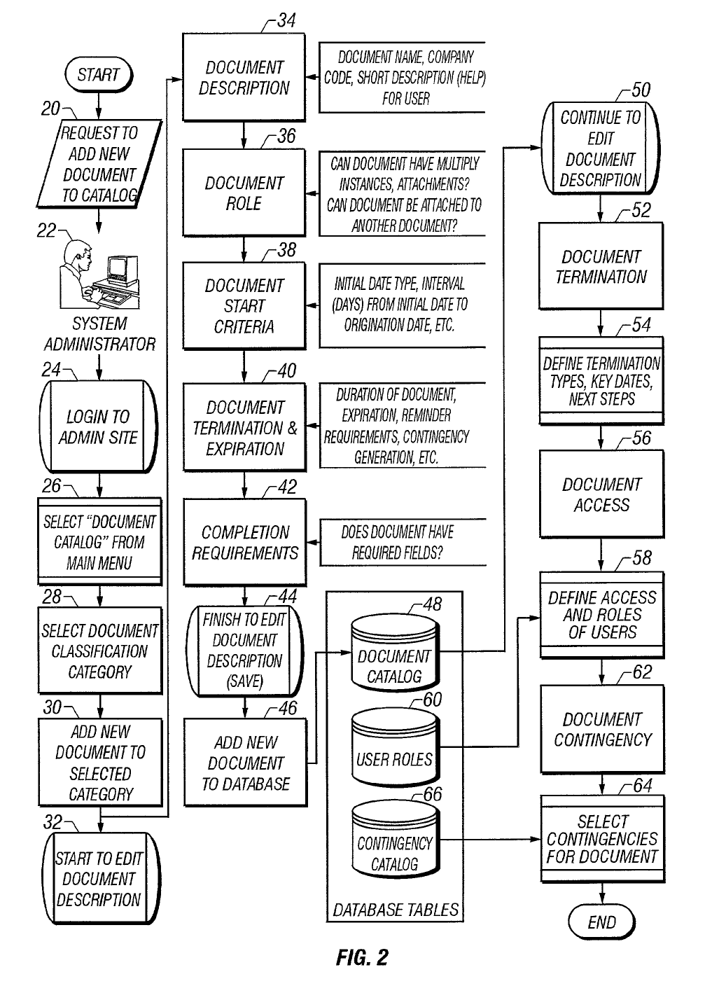

FIG. 2 is a flowchart illustrating document processing in a document catalog in accordance with the present invention. The processing begins with a request to add a new document to the catalog (i.e. library) (Block 20). A system administrator (22) receives the request and logs in to the administration site (Block 24) and selects “Document Catalog” from the main menu (Block 26). A classification category is selected (Block 28) for the document to be added and the new document is then added to the selected category (Block 30). The document description editing process is begun (Block 32) to add the document description (Block 34) of the newly added document. The document description (Block 34) may include a document role (Block 36), document start criteria (Block 38), document termination and expiration (Block 40), and completion requirements (Block 42). Upon completion of editing the document description, the edits are saved (Block 44) to a document catalog database table (Block 48).

Document description data stored in the document catalog database table (Block 48) may be extracted in order to continue to edit the document description (Block 50) in order to provide more detailed descriptive information. Document termination may be further defined (Block 52), as may be termination types, key dates, and various other information affecting the document (Block 54). Document access may also be defined at this stage (Block 56). Document access can be defined at the user role stage, being defined according to the role of the user (Block 58). User role information may be extracted from a database table of user roles (Block 60). Document contingencies can be defined (Block 62) in the continue to edit process and contingencies for the document can be selected (Block 64), the contingency selection criteria determined utilizing data from the contingency catalog database table (Block 66).

More specifically, in accordance with the present invention, the document catalog is a library of document titles, organized by categories, types, or document names. The document catalog also includes document descriptions of their use within a business process structure. The HTML template files can reside inside or outside of the database and may be created by any HTML editing tools. Further, these templates include the document static source text, the document layout, and the areas marked to locate the placement of the dynamic (i.e. variable) inserted user entered data or the database transferred data.

An application user (administrator level) receives a request to add a new document to the document library. The administrator logs onto the system and enters the document library. The administrator selects the appropriate document category for the new document and selects the “add document” link. The addition of the new document to the library occurs and the administrator then edits the descriptive document information requirements. The information that may be edited includes document role and how the document initiates, terminates, and expires. Specific requirements information regarding description of newly added documents may also be provided to the document library.

The new document, along with the edits thereto, is added to the document catalog database table. Thereafter, additional information may be provided to define more detailed document descriptive information. For example, detailed termination and transition information may be provided, as well as date types affecting the scheduling of the document, what application user roles can access the document, or whether the document includes contingencies, and the specific contingencies it can include. The administrator may define user roles, as well as access levels associated with the defined roles. All this data may be saved in the database, of which the database tables are a part.

As will be explained, catalogs that exist at the system level can be distributed to the client level. A client administrator may access the system level document catalog contents to select specific documents to be copied to the client catalogs. The client can define their database requirements to match the needs of their basic business requirements and the business process requirements associated therewith.

Any number of documents can be dependent upon another document. Based on the business process requirements of the particular business (i.e. business object), the client can add a new document to any business object status (i.e. a step in the process of a particular business, discussed in detail later in the application) from their existing document description library, or create a new document and document description and add it to the business process as needed.

The document description (Block 34) may include the document name, the company code, a short description of the document as a help option for the user, etc. The company code may be a numeric or letter code, or alphanumeric code, utilized by a particular company to identify the document.

The document role (Block 36) may indicate the functionality or condition of the document. For example, can the document have multiple instances, multiple attachments, etc.? As another example, it may indicate whether the document may be attached or otherwise associated with another document.

The document start criteria (Block 38) can include various scheduling data. For example, initial date type, interval (days) from initial date to origination date, etc. can be included.

Document termination and expiration (Block 40) can include information such as the duration of the document, the expiration of the document, reminder requirements, contingency generation, etc.

Completion requirements (Block 42) can include information such as whether the document has required fields, etc.

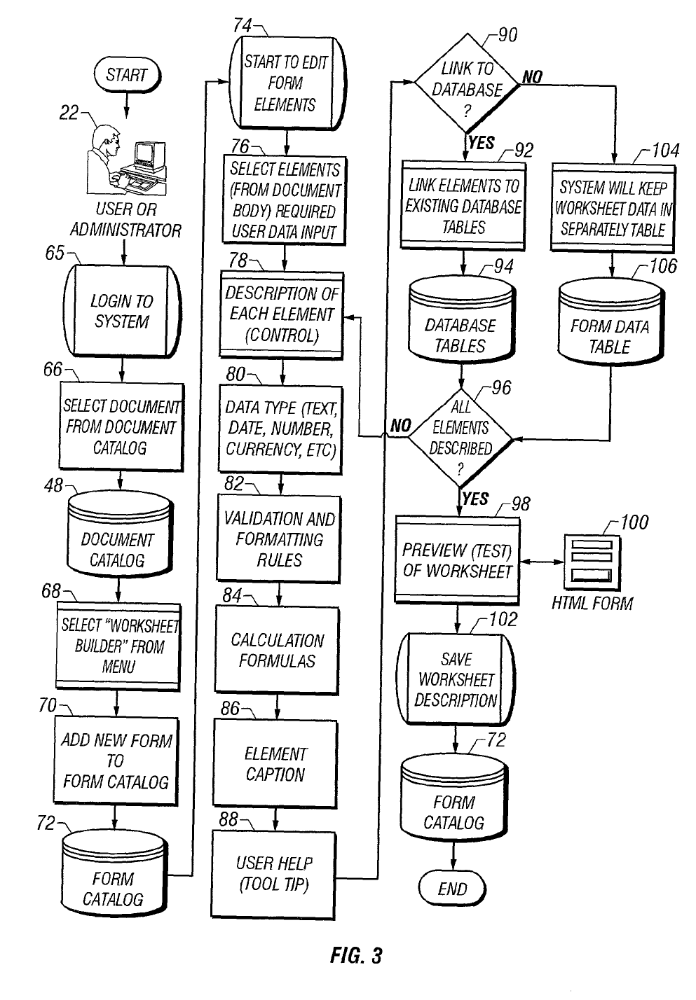

FIG. 3 is a flowchart illustrating worksheet generation in accordance with the present invention. As discussed previously, the user can input data to a worksheet description that corresponds to the document selected by the user from the document library. In this case, the user is a participant user of the system, rather than an administrator level user that actually helps to provide services to the participant user. Using a real estate example, as a business process, some typical user types of the system may include the listing agent, seller, any one of a number of vendors (e.g. lender, termite inspector, etc.), real estate office manager, and office administrator to name a few. All of these participants have specific roles and duties within the business process. A system functional level above these business process user types is also provided within the system. Within any common functional user group, an administrator can be supported. In this situation, the administrator can perform document building, maintenance and integration functions for a group of users sharing common business process documents library contents. This administration technique lends common controls within a group of users. However, the system supports individual users having complete document library function and control.

For the process of generating the worksheet, the system administrator (22), or a user of the system, logs in to the system (Block 65). In this instance, the system administrator (22), or user, selects a document from a document catalog (block 66) which is accessed in the document catalog database table (Block 48). The user or system administrator (22) then selects the “worksheet builder” option from the menu (Block 68). The new form is added to the form catalog (Block 70) and the new form is saved in the form catalog database table (Block 72).

The process to edit form elements (Block 74) is begun. The elements that require user data input are selected from the document body (Block 76). Each element is described (Block 78). The worksheet defines the components of the document form. For example, data type such as text, date, number, currency, etc. (Block 80) are defined. Validation and formatting rules (Block 82) are applied to the data, as are calculation formulas (Block 84). A caption for each element (Block 86) may also be included in order to assist the user in completing the worksheet. Furthermore, other forms of user help, such as tool tips, may be included (Block 88) in order to provide assistance to the user. Tool tips are a method of providing short help and/or descriptive phrases about the interface element positioned in the geographical position of the mouse cursor. This help text/descriptive phrase is displayed briefly or until the mouse is moved off the interface element.

A link to a database may or may not be chosen (Block 90). If the database link is chosen, the elements are linked to existing database tables (Block 92), the database tables (Block 94) residing in the database. The system determines whether all the elements have been included on the worksheet (Block 96) and provides a preview of the worksheet (Block 98) to the user if the elements have all been included. The preview is provided preferably in HTML format (Block 100), but may be in any other format suitable for use with the present invention. The description of the worksheet is saved (Block 102) to the form catalog (Block 72) table in the database. To reiterate, the form catalog is at the system level, but forms selected by the client and/or a client user may be distributed to the client form catalog.

Returning to the determination of whether all elements are included on the worksheet (Block 96), the control step of describing each element (Block 78) is returned to in the event that all elements have not been included. Similarly, where no link to a database has been provided, the form data is kept separately in a table (Block 104) called the form data table (Block 106) and the process returns to the description of each element (Block 78) step if the data in the form data table (Block 106) does not include all elements (Block 96). However, if the data in the form data table (Block 106) does include all elements (Block 96) the aforementioned process of allowing a preview of the worksheet (Block 98) and saving the worksheet description (Block 102) in the form catalog database table (Block 72) is completed.

The administrator, or user, performs the above discussed process once the catalog entry, discussed in FIG. 2, has been completed. In other words, the user or administrator selects a document and prepares an input form therefor by selecting the worksheet builder option.

The worksheet builder is the place where the document elements are specified, their functions are defined, the definition of links to database fields are connected to the values specified by the user at document data entry time. During this worksheet design (i.e. generation) cycle, a preview of the worksheet can be requested of the system to aid in the visual appeal of the input form during the worksheet building process as well as after the input of the document dynamic data. The worksheet defines all document form components including the text areas, input element types, data type specifications, data format requirements and descriptions, input data formulas and calculations used for post data input processing, as well as local captions and user help information as it will all be used and formatted in the final version of the user document.

The document worksheet builder provides an interface for system users to design the input form for the dynamic data for each document added to their library in the design phase. When the design of the input form is complete, and all data input or output requirements for each document have been defined, the worksheet is then used to accept the variable, dynamic data which is required by the document within the business process. The user enters the dynamic data fields within a document with a name for the field, or a caption to capture the essence of the worksheet prompt for the input selection or specification.

The system assigns and utilizes a data control identifier at the time the user adds the data control to the worksheet. The worksheet supports multiple user-specified dynamic document input types. These may include text areas, listbox and combination box input selection devices, freeform user selection inputs, check boxes, and other typical input form data selection controls. The system also allows the user to specify database contents that can be linked to an input area. The system will then populate the document with the data value at the specified database location. Input data formatting requirements can be system maintained with integrated masked input disciplines.

With respect to the various foregoing descriptions of document and worksheet, main functions can be provided at the single user level, or the entire process can be administered at the enterprise level by an administrator or librarian to control document inventory, document versions, and document content control for the enterprise document user-base.

Returning to the idea of the worksheet preview, the document may be viewed in the user browser when, upon user request, the system sends the HTML document template and when the worksheet user input files are converted to HTML via server side active server page technology and presented to the user in the user browser. The system database uses the system assigned data control identifier from the selected document worksheet and the HTML document template. This process provides the correct data values in the correct locations on the final version of the displayed document via database stored procedures that are processed on the database server.

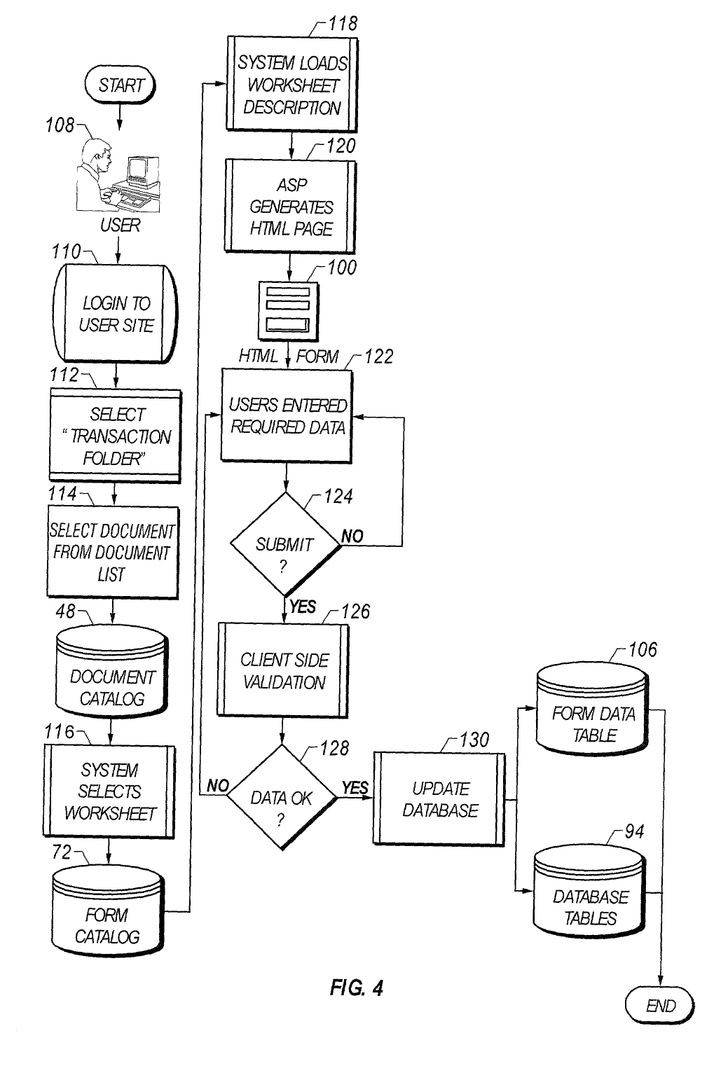

Turning now to user interaction with the worksheet, FIG. 4 is a flowchart illustrating user input into a worksheet in accordance with the present invention. The user (Block 108) logs in to a user site (Bloc 110) and selects “transaction folder” (Block 112). Upon selecting “transaction folder,” the user is presented with a document list. The user selects a document from the document list (Block 114) and the document is retrieved from the document catalog, i.e. library (Block 48). The system selects a worksheet (Block 116) with information corresponding to the document selected by the user. The user may need to request the worksheet description, as previously discussed. The form catalog (Block 72) is accessed in order to retrieve the worksheet description and the system then loads the worksheet description (Block 118) for generation of an HTML page by the active server page (Block 120).

The HTML form (Block 100) of the worksheet is presented to the user and the user is allowed to enter required data (Block 122) in the variable data fields. Once the required data fields have been completed by the user, the form is submitted (Block 124) to the client side for validation (Block 126). Client side scripting confirms data validation procedures based on element description in the worksheet (Block 82). It is basically script code embedded in the HTML pages viewed by the user that ensures data input meet the requirement of the data type and data format. If the data entered by the user is acceptable (Block 128), it is utilized to update the database (Block 130) and the tables included therein (Block 106, Block 94). However, if it is determined that the data is not acceptable (Block 128), the user must again enter the required data on the form. Similarly, the user must again enter the required data (Block 122) where there is some type of failure to submit the completed form (Block 124).

To recap the above described process, the user selects the document from the document list and requests the worksheet for the particular document chosen. The worksheet created by the administrator, described in FIG. 3, is displayed to the user. The worksheet is the input form for the document instance. The worksheet represents a brief version of the complete document.

Further, the worksheet contains only the variable elements of the selected document. In other words, it includes only information that is meant to be modified, according to the particular user or particular situation, and the user only provides the information that is not the standard document contents. For example, an account owner only enters information into pre-printed checks, the information entered changing depending on the situation. Items such as the name, address, date line, signature line, etc. generally remain the same. The worksheet form typically does not contain static (i.e. fixed) document text. To utilize the check example once again, only the spaces for the check writer to fill in the data, amount, and signature would appear on the worksheet.

Upon the receipt of the user request for the worksheet, the system loads the document description and an active server page generates the HTML form to show the worksheet form in the user browser. The user enters the dynamic form data and the client side scripts confirm data validation functions. This client side program (scripts) may be distributed via an active server page in the worksheet pages viewed in the client browser, the scripts validate user input for correct data types and formats. The system then updates the user inputted data in the worksheet form data table and corresponding database tables.

As previously discussed, the user input may be via a wireless device, a handheld device, a computing device, or a telephonic device, or any other device or mechanism suitable for allowing user input in accordance with the present invention. The document worksheet may be created in different versions for the different devices from which the system may receive input. As an example from the foregoing list of devices, data from a hand held device, such as those based on Windows CE (TM), can be supported because the worksheet does not require a full document body display. The worksheet may be created in a version for small screens for hand held devices. Accordingly, the small screen features of the hand held device would not preclude entering information into a worksheet thereon. Further, hand held devices may be utilized to provide electronic hand writing signature.

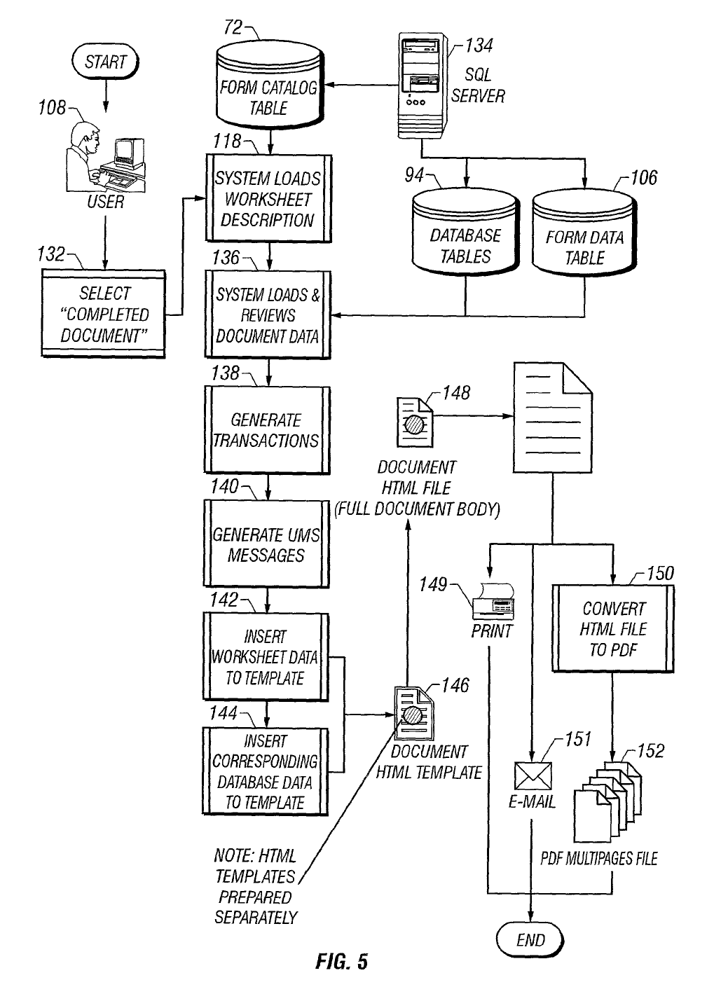

The worksheet data discussed above can be combined with the static data (i.e. fixed data) included on the document in order for the user to readily utilize the information contained in the document and worksheet, for example, in order for the user to print a useable form. FIG. 5 is a flowchart illustrating the merger of worksheet data with document data for display of the resulting file in accordance with the present invention.

The user (108) selects “completed document” (Block 132) and the system thereafter loads the worksheet description (Block 118). The worksheet description is retrieved from the form catalog table (Block 72), which shares information with the database tables (Block 94) and the form data table (Block 106) via an SQL server (Block 134). The system loads and reviews the document data (Block 136), the document data being retrieved from the database tables (Block 94) and form data table (Block 106).

Transactions are generated (Block 138) utilizing the data from the three database sources and UMS messages are generated (Block 140). The User Messaging System (UMS) and transactions will be described later in the application in further detail. The worksheet data is inserted into a template (Block 142) along with inserted corresponding database data (Block 144). The template is preferably an HTML template (Block 146), which is typically prepared separately. In other words, HTML template generation is not part of the above-described process. The new document is utilized to form a full document body HTML file document (Block 148). Preferably, the HTML file is converted into a PDF file (Block 150) and displayed to the user in a PDF multipages file (152). As shown, the document file may be printed (149), emailed (attachment) (151), or distributed online to other users.

This process allows the user to view and print the form. As an overview of the above described process, the user selects the “completed document” option following the completion of the worksheet form input cycle, discussed in FIG. 4. The system then pulls data from the database for the worksheet form description, the worksheet form user data from the data table, and database tables to review complete document data. The document data is reviewed for the purpose of generating transactions from user data inputs, initiating defined messaging procedures, performing database web functions and formatting the HTML document by inserting worksheet form specifications and user worksheet input to the HTML template file and sending the finished document to the user browser in the form of an HTML file. In other words, the worksheet input is combined with the document description in the user browser, thus, creating the HTML file. This HTML file is then converted to a Portable Document Format (“PDF”) document by user request for user printing and distribution as required by the features of the application. The HTML version of the document may also be printed, emailed, or distributed online.

The HTML template is built utilizing the HTML document template builder, which may be a simple HTML editor. The HTML editor is not unique, but it can be adapted for the goals of building the specific type of template discussed above. The template may be an HTML file including static text and defined placeholders where user data input or database output are required of the user during the business process when the document is used.

A document data integrator provides population HTML template file by data, entered by user and data existing in the database. All placeholders, defined in the HTML template, are replaced by required data and a completed document HTML is created for output.

A database stores the database tables from which various information is extracted, as discussed above. Another database may also be included for maintaining document data in an “as-is” type condition and for supporting data exchange between the various documents. Furthermore, a paper-less document folder may be created for storing multiple instances of documents and addendums.

Within a business process, the status of the business process may change as specific events occur. Accordingly, specific documents can be linked to specific business statuses, described later in the application, so that appropriate documents are active within the correct status of a business process.

The description of the document supports conditions that initiate, terminate, and define document access and output distribution between any typical business situation involving multiple user types. Limitations and access to documents are appropriated to defined roles.

The documents may be used inter-dependently. The user provided input can trigger dependent events, scheduled activities, and change the business status of a related business process. The document contents can be changed and/or updated. Furthermore, newly created documents can be integrated into existing business processes, as well as the document library of any user or enterprise.

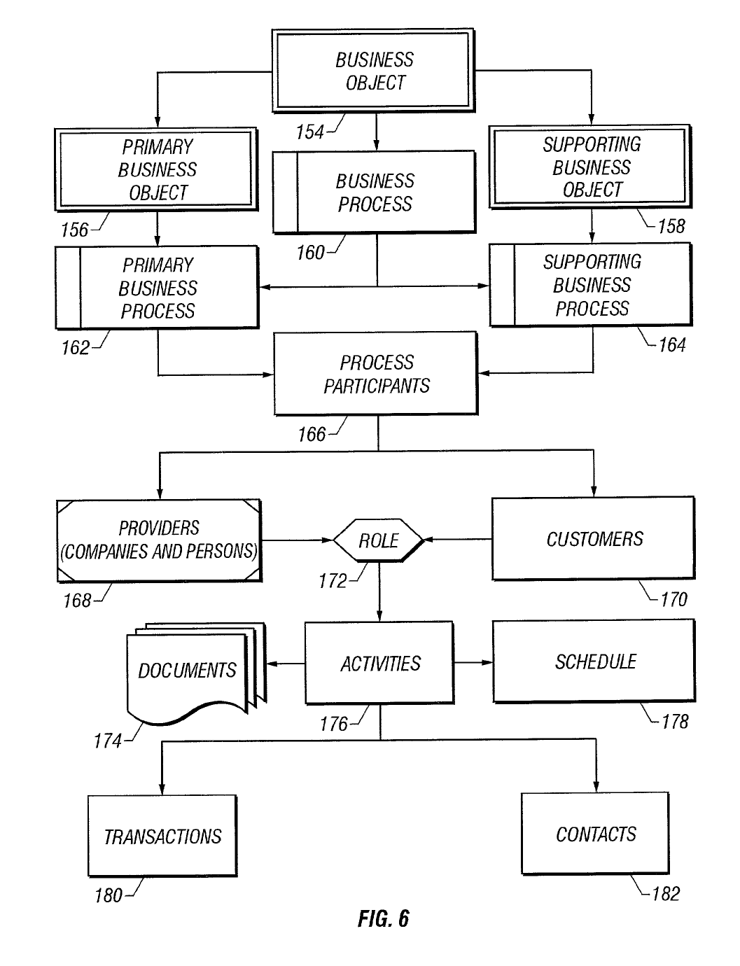

Referring to a contextual description of the present invention, FIG. 6 is a flowchart illustrating a business environment in which a document is utilized. The documents (174) in the current flowchart constitute an activity (block 176) of the larger business process. The business object (Block 154) is the type of business using the application of the system. For example, a real estate company may be a business object, or a law firm, etc. The primary business object (Block 156) is the main object of the application. For example, for real estate sales, it may be the process of listing and selling real property. In order to reach the main goal of the primary business object (Block 156), the business process (Block 160) requires the services provided by the supporting business object (Block 158). The business process (Block 160) entails fulfilling the requirements of the business object. In other words, the requirements of the business object need to be followed to complete the goals of that business, at which point, the business process (Block 160) is complete.

Each of the primary business processes (Block 162) and the supporting business processes (Block 164) include process participants (Block 166) involved in their business processes (Block 160). For example, real estate agents are involved with the primary business object and escrow officers, termite inspectors, etc. constitute process participants (Block 166). The process participants (Block 166) perform functions required of their business objects (Block 156, 158). Process participants (Block 166) may be categorized as providers (Block 168), such as the companies and people working within the companies that provide the goods and/or services within any defined business process. Further included as process participants (Block 166) may be customers (Block 170), customers being the people or companies that rely on and pay for the goods and services made available by the providers.

Within this business relationship of providers (Block 168) and customers (Block 170), each person involved has a role (Block 172) to play. Each role (Block 172) has associated tasks to perform. These tasks are called activities (Block 176). The activities can involve documents (Block 174). The documents (Block 174) may be, for example, sales contracts, inspection reports, service invoices, etc. The activities may require certain scheduling (Block 178) for their completion at a certain time, on a certain date, etc. Furthermore, the activities can create an item or group of items to be completed based on the requirements of the provider/customer relationship. The requirements can be interrelated, completion dependent, timeframe oriented, or a host of any other possible variations which are requirements of the business process (Block 160). This collection of business base level activities are known as transactions (Block 180) and the communications between the persons during the activity processing in order to complete the requirements of a particular activity are known as contacts (Block 182). By providing a logging process for each contact (Block 182) a contact history is created for each object logging contacts during each session. A contact system will be described later in detail.

The system of the present invention typically supports business processes that can be defined as having various steps that must be processed and can be identified and tracked though the completion of the business process. The various states can be associated with an object status, the completion of the object business process being the completion of all of the object statuses defined within the business process. The participants within the process, discussed above, may be companies, persons, vendors, service providers and/or customers that are involved in activities within that business process. The activities, such as the previously discussed documents, transactions, contacts, etc., are the business object requirements that the participants use to achieve the completion of a defined business object status.

To clarify, a transaction is merely an item which can be scheduled in some sequence, can have an effect on other transactions, can create a triggering event for other documents, can change the status of the business process, or change the status of the document itself, and can have many other controlling features which all have a unique definition according to the user specified transaction description. Simply stated, a transaction is an event which may have a name, is capable of being scheduled, has a beginning, a duration, an end, is capable of having multiple status conditions during its duration, etc.

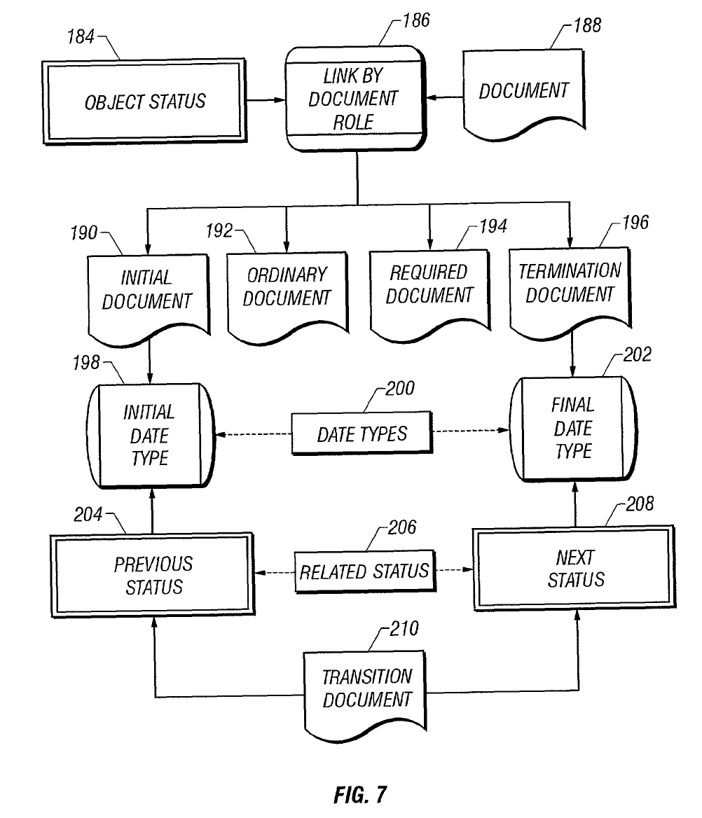

Now that the context of where a document may be found or needed in a business environment can be better understood, the connection between a document within a business process and the way it is associated with that process will be explained in FIG. 7. An object status (Block 184) within the business process definition can be linked to a document, by document role (Block 186). In other words, documents (Block 188) have various roles within a defined status. For example an initial document (Block 190) begins a business process status, while a termination document (Block 196) ends that business process status. An ordinary document (block 192) may be used within the business process without having an effect upon the initiating or terminating of the business process status. However, a required document (Block 194) is required during the business process status.

The documents may have relationships to each other, for example interdependencies, such as requirements based on dates. In the flowchart of FIG. 7, this is indicated by an initial date type (Block 198) associated with the initial document (Block 190). This initial date type (Block 198) has a relationship of date types (Block 200) with the final date type (Block 202) associated with the termination document (Block 196). The date type (Block 200) may help to determine whether the business process status has begun, has been completed, or is somewhere in between the two endpoints. For example, in a patent practice, an initial document might be an engagement letter between the firm and the client, while a termination document might be the patent application filed with the USPTO.

Furthermore, a previous status (Block 204) and a next status (Block 208) are both related statuses (Block 206), since one triggers the beginning of the current status, while the latter indicates the need to begin a new status. A transition document (Block 210) helps to provide the statuses by identifying the completion of the current business object status (Block 184) and initiating the next business object status (Block 184) within the business process.

The defined object status corresponds to the start of a next step in the business process. This process is repeated until all of the defined steps of the business process have been completed to the end of the business process.

Each status can have pre-defined documents associated with the status. Documents are capable of generating transactions and transactions can be scheduled and can have a status (i.e. stages) of completion. The completion of a status and document of a transaction can trigger the start of another status, document, or transaction. The business process of the business object establishes the requirements of what status, document, and transaction need to be linked to the business description items so as to be able to provide a system level solution which meets the needs of the business process and the business object.

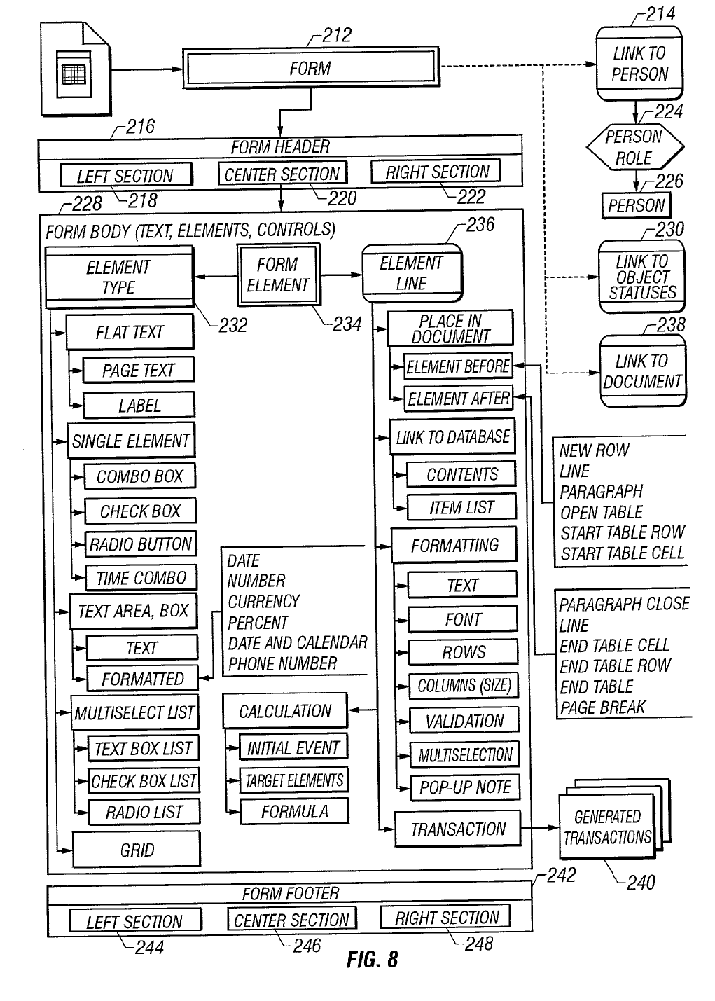

The status within the business process (Block 230), discussed above, may be linked to a form (worksheet) (Block 212) discussed in FIGS, 3, 4, and 5. FIG. 8 is a schematic diagram illustrating a possible layout of a worksheet in accordance with the present invention. The worksheet (Block 212) is also linked (Block 214) to the person (Block 226) with the role defined as person (Block 224). As previously discussed, the worksheet (Block 212) is the screen version of the document for the user to view and edit the document. The worksheet (Block 212) is also linked to the document (Block 238).

The worksheet (Block 212) can consist of three main regions, namely the form header (Block 216), the form body (Block 228), and the form footer (Block 242). The form header (Block 216) and the form footer (Block 242) are typically narrow regions across the full width of the form body (Block 228) and are used to provide items such as document name, a logo, the date, user company name, etc. in the header area and page numbering, copyright information, etc. in the form footer (Block 242) area. Both the form header (Block 216) and the form footer (Block 242) may be divided into three sections each, namely the left section (Blocks 218, 244), the center section (Blocks 220, 246), and the right section (Blocks 222, 248). These sections can support text editing, the placement of graphics and logos, the placing of database field contents into designated target areas, etc.

The form body (Block 228) area is the main portion of the page, which contains the worksheet element (Block 234), discussed at Block 96 in FIG. 3, which is linked to the element type (Block 232). A definition of a worksheet element may be any document text and/or any data entry device of any kind. The worksheet (Block 212) may be created by the user by the user putting elements together to create a form which can accept user input, the input stored to the database fields specified in the element database linkage description. The worksheet element has a link which specifies its place in the document, before or after an other element, its link to the database, the element formatting requirement, any transaction description requirements which may be generated etc.

The element type (Block 232) may consist of text and labels within the body of the form, single elements, text areas, text boxes, multiselect lists, grids, etc that can be used for input. The input devices may include, for example, page text, check boxes, text box list, etc. and can be managed with pre-defined formatting requirements and input masks for data validation purposes by date, number, currency, etc. masked input controls.

The element link (Block 236) between the element type (Block 232) and the worksheet element (Block 234) can describe the calculations which are to be performed based on the input received by the element at user input time. The description defines the initial event, the target elements affected by the calculation, and the formula of the element's calculation. That same link (Block 236) may support a transaction description which specifies the function of the transaction based on the user input of the element. The grid data format can also be supported and can be described.

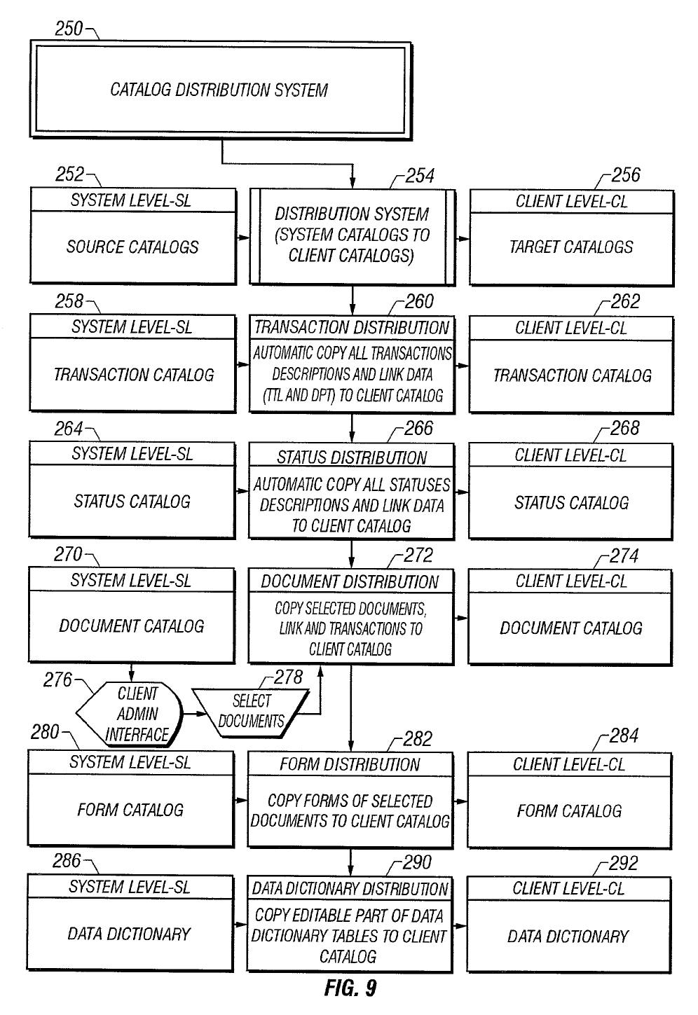

FIG. 9 is a flowchart illustrating two levels of catalogs utilized by the application to distribute application components to the user. The catalog distribution system (Block 250) distributes the two levels of catalogs. The primary level is the collection of catalogs, which can be maintained by the system administrator (22), and are knows as the system level of the application catalog configuration. The second catalog level may be at the client level and the catalogs are therefore referred to as client level catalogs. The distribution from the system level catalogs to the client level catalogs is handled by the distribution system (Block 254). In general, the target catalogs configurations (Block 256) are identical to the source catalogs (Block 252) configurations with some exceptions.

The contents are copied from the system level catalogs to the client level catalogs by the distribution system (Block 254). The system level source catalogs (Block 252), transaction catalog (Block 258), status catalog (Block 264), form catalog (Block 280), and data dictionary (Block 286), distribute particular individual catalog contents and link data (Blocks 260, 266, 272, 282, and 290) to the appropriate client level catalogs (Blocks 256, 262, 268, 274, and 284) and client level data dictionary (Block 292). The document catalog (Block 270) differs from others in the distribution process in so far as the client administrator (Block 276) may access the system level document catalog contents (Block 272). The form distribution from the system level catalog to the client level catalog performs in the same manner as the other catalog distribution process, except in this case the system level form catalog provides only the forms of the selected documents (Block 278) chosen by the client administrator (Block 276) from the system level form catalog (Block 280).

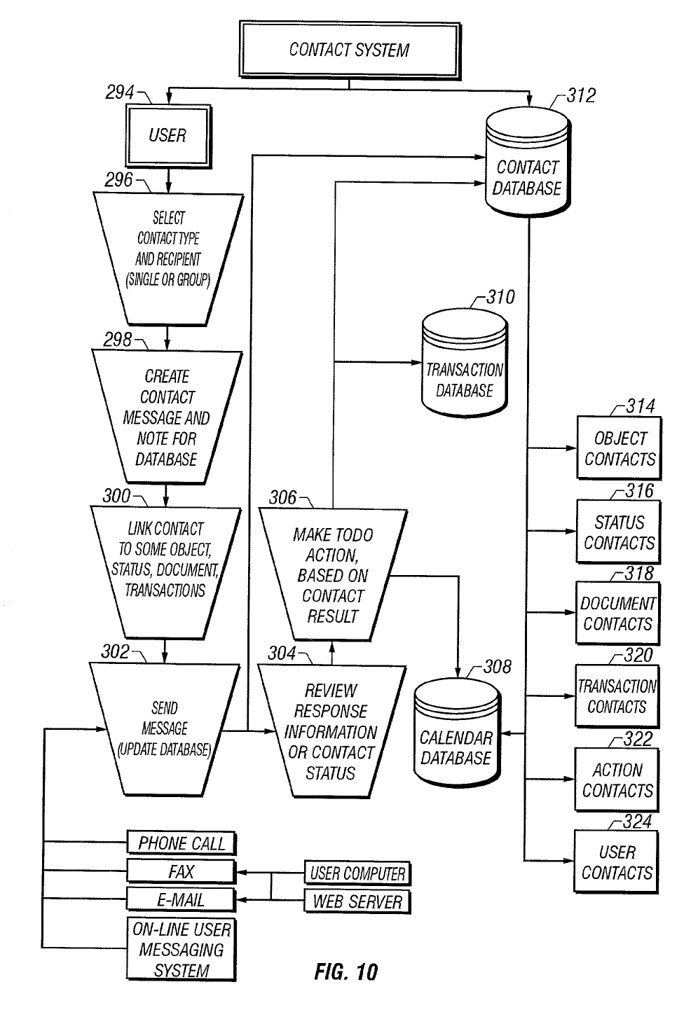

As described above with respect to FIG. 6, the collection of business process requirements are referred to as transactions (Block 180) and the people who are communicated with during the activity processing in order to complete the requirements of the particular activity are known as contacts (Block 182). FIG. 10 is a flowchart illustrating the contact system in accordance with the present invention. All user contacts related to any object, status, document, transaction, and action may be tracked and utilized to create a contact history file for the user. For certain contacts, such as email or on-line communication (like the user messaging system), the contact information is recorded, thereby creating a user history. For phone, fax, contact by letter, etc. the user (294) of the contact system selects the contact type and recipient (single or group) (Block 296) and creates a contact message and note for the database following selection of the “add a new contact” option. The contact message and note is linked to an object, status, document, or transaction (Block 300) and the message is sent (Block 302). The message may be sent via phone call, fax, email on-line user messaging system, etc.

The response information or contact status can be reviewed (Block 304) by the user (294) and a “to do action” can be created based on the contact result (Block 306), which is then stored in the contact database (Block 312), which records the information based on the link (Block 300). The contact database (Block 312) places the information in the correct contact database location, such as the object contacts (Block 314), the status contacts (Block 316), the document contacts (Block 318), the transaction contacts (Block 320), the actions contacts (Block 322), or the user contacts (Block 324). The contact information is then posted to the calendar database (Block 308) and the transaction database (Block 310). In the event the contact requires the recipient to return information to the user after the contact has been added to the database contact record, the user can select the contact record and update the response information.

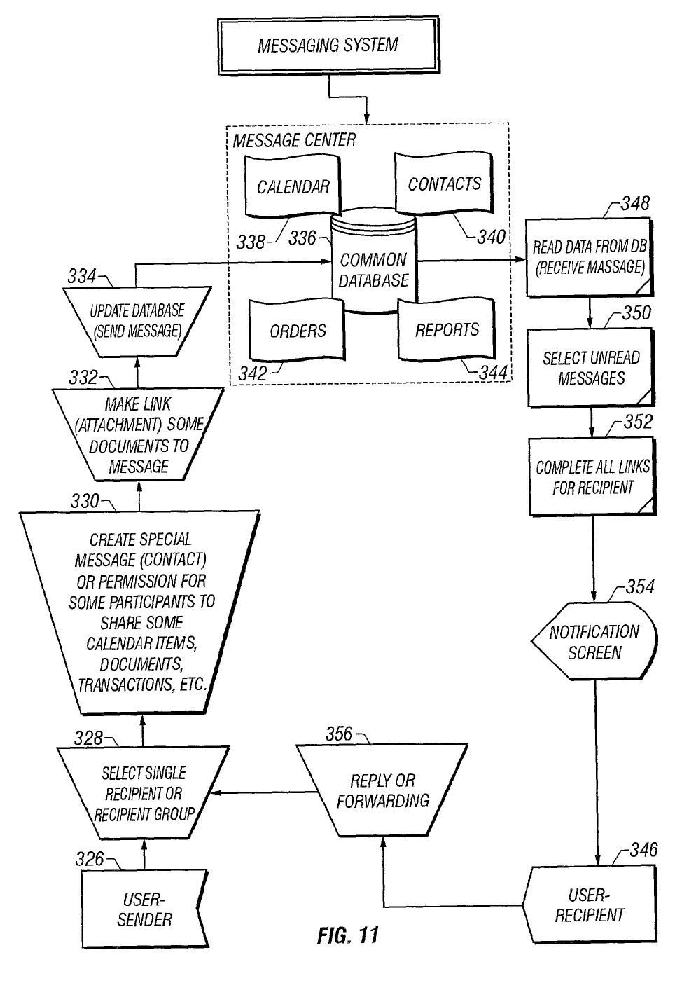

The user messaging system discussed briefly above is illustrated in a flowchart in FIG. 11. Contacts between participants of the business process system may be supported by sharing database data. A user-sender (Block 326) may select a single recipient or recipient group to receive a message from the user-sender (326). The user messaging system (UMS) can provide an input screen to allow the user-sender (326) to enter a text message. Further, the user may provide access permission to the recipient user (346) of items in a common database (Block 336). For example, permission to access the calendar (Block 338), the contacts (Block 340), the orders (Block 342), the reports (Block 344), or other business object data associated with the user may be granted.

Where a document is involved, the sender can attach the document to the message (Block 332) by creating a link. The sender (326) forwards the message and it is received by the database (336). The data may be read from the database (Block 348) and the unread messages selected (Block 350). The recipient user (346) receives notification of an unread message via a notification screen (Block 354) and opens the message to read its contents, as well as to access any linked business object data. The message is marked as read. The recipient (346) may reply to the sender or forward (Block 356) the message to another user or group of users.

The UMS is basically a database supporting a communications system between users of the online document system of the present invention. UMS is not an email system and does not replace other types of communication systems. Rather, UMS provides a method for any user with an active connection to the document system to communicate with another active member of the system.

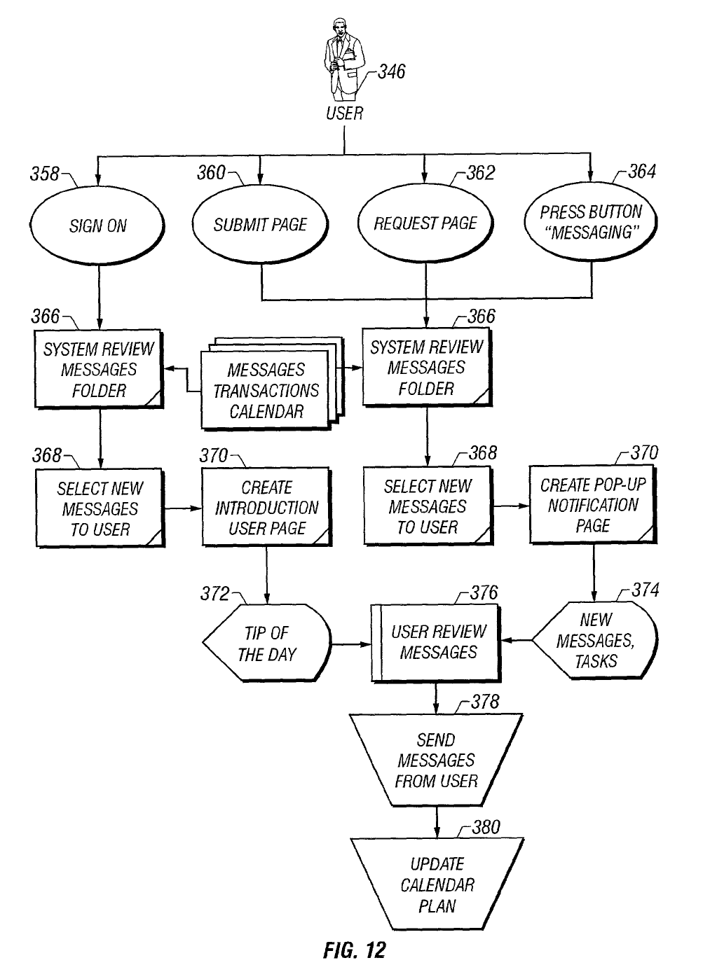

FIG. 12 is a flowchart illustrating the process utilized by the user-recipient to retrieve messages sent by the user-sender. As discussed in FIG. 11, a user sender (326) may send a message, or attachment, etc. to a user recipient (346) who is an active member of the document system (i.e. logged in). The user (346) may retrieve messages on the bulletin board page when the user logs in (Block 358) or by opining the bulletin board (360) at any time. Background checking of new messages, where the system performs message checking for new messages for all users during their active session, may be provided when any page is submitted (360) during the online session, or when a page is requested (Block 362), or by clicking the “messaging” system button (Block 364).

If the messages folder is reviewed at logon time (Block 358), the new user messages are selected, the system reviews the messages folder (Block 366) and selects the new messages to the user (Block 368) from the messaging center. An introduction page is created (370) for the user (346), a tip of the day is displayed (Block 372), and the messages are formatted for the user to review (Block 376). If the messages folder is reviewed at page submission time (Block 360), page request time (Block 362), or by the user selecting the “messaging” button (Block 364), the new messages are selected (Block 368) and a pop-up notification form is created (Block 370) displaying the new messages or tasks (Block 374) for the user to review (Block 376). UMS includes information to describe messages, transactions, and calendar scheduling as three individual items, rather than a single bundle.

The user (346) can respond by sending a response or new messages (block 378) and/or can edit and add the required “to do action” based on the content of the newly received message. The calendar plan (Block 380) then updates this newly entered “to do action” associated with the appropriate object specified by the message.

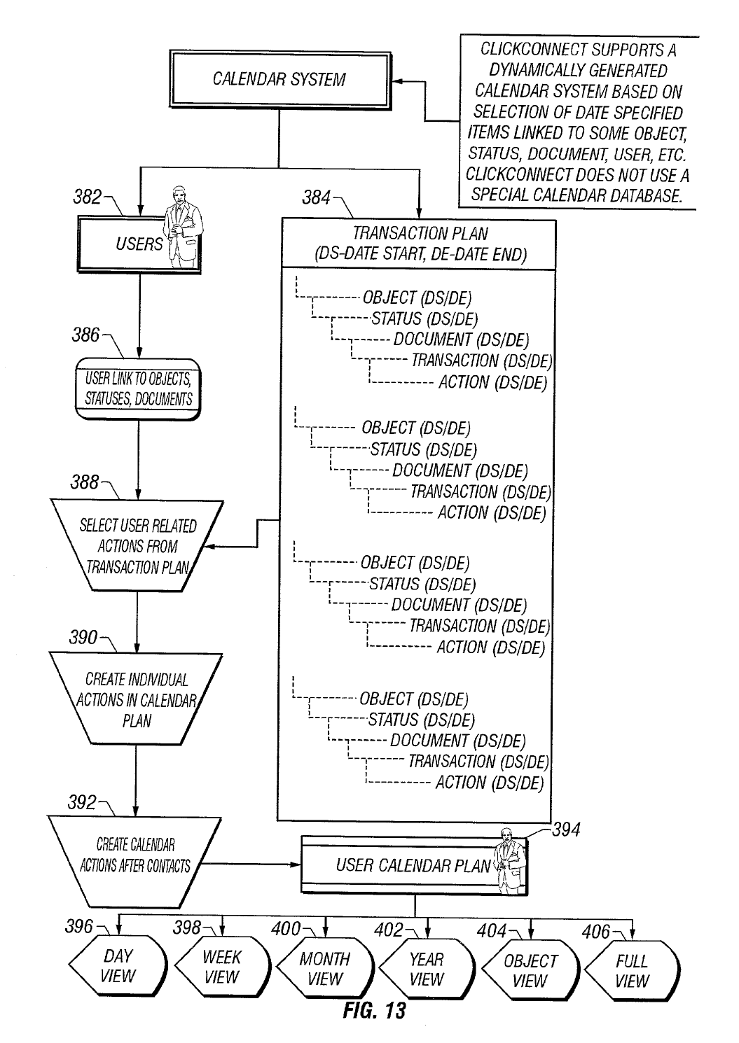

As discussed above, a user may have a calendar (Block 338 in FIG. 11), stored in a common database (Block 336 in FIG. 11). FIG. 13 is a flowchart illustrating a calendar system in accordance with the present invention. The calendar system populates the calendar items from the user's (382) individual transactions, which, when posted in calendar format make up the schedule of the transaction plan (Block 384). User activities create links to the business objects involved in the activities, such as objects, statuses, documents, etc. (block 386). User related actions may be selected (Block 388) and utilized to create individual actions in a calendar plan (Block 390). Calendar actions are created (Block 392), after contacts, and added to the user calendar plan (Block 394). The user calendar plan (Block 394). The calendar may be viewed according to time, such as day view (396), week view (398), month view (400), or year view (402) or according to other perspectives, such as object view (404) or full view (406).

A separate calendar database is not used for the calendar system. The dynamically generated calendar system is based on the selection of date specified items linked to some object, status, document, user, etc. All date and time link data, such as transactions, contacts, orders, actions, messages, etc., is stored in a common transaction database.

While the invention has been particularly shown and described with reference to certain preferred embodiment(s), it will be understood by those skilled in the art that various alterations and modifications in form and detail may be made therein. Accordingly, it is intended that the following claims cover all such alterations and modifications as fall within the true spirit and scope of the invention.

What is claimed is:

1. A method for providing an online document and input form creation and storage system comprising the steps of:
(a) providing online tools enabling users to develop documents including fixed data and variable data and a worksheet relating to the variable data;
(b) providing a library in which documents developed by the users are stored, the library being remotely accessible;
(c) allowing a particular user to select a document from the library;
(d) providing to the particular user a worksheet corresponding to the document selected;
(e) allowing the user to input variable data into the worksheet;
(f) merging the user input data from the worksheet with the fixed data from the document selected to develop a document file; and
(g) utilizing the document file to display to the user a completed document including the merged data.

2. A method as recited in claim 1, wherein the document file including the merged data is an HTML file.

3. A method as recited in claim 1, further comprising displaying the completed document in a user specified format.

4. A method as recited in claim 1, wherein the document library includes document titles organized according to at least one of a category, a type, and an HTML template file name.

5. A method as recited in claim 1, further comprising allowing a user to add a new document to the document library.

6. A method as recited in claim 5, wherein user authorization is required in order to allow the user to add the new document to the library.

7. A method as recited in claim 1, wherein user authorization is required in order for the user to be allowed to select the document from the document library.

8. A method as recited in claim 1, wherein the worksheet includes input fields for the input of variable elements of the document selected.

9. A method as recited in claim 1, wherein the data from the document includes non-variable data.

10. A method as recited in claim 1, wherein the data input by the user includes data input via at least one of a wireless communication device, a handheld device, a computing device, and a telephonic device.

11. A method as recited in claim 1, wherein after selecting the document the user requests a corresponding worksheet.

12. An apparatus for providing an online document and input form creation and storage system comprising:
(a) means for providing online tools enabling users to develop documents including fixed data and variable data and a worksheet relating to the variable data;
(b) means for providing a library in which documents developed by the users are stored, the library being remotely accessible;
(c) means for means for allowing a particular user to select a document from the library;
(d) means for providing to the particular user a worksheet corresponding to the document selected;
(e) means for allowing the user to input variable data into the worksheet;
(f) means for merging the user input data from the worksheet with the fixed data from the document selected to develop a document file; and
(g) means for utilizing the document file to display to the user a completed document including the merged data.

13. An apparatus as recited in claim 12, wherein the document file including the merged data is an HTML file.

14. An apparatus as recited in claim 12, further comprising means for displaying the completed document in a user specified format.

15. An apparatus as recited in claim 12, wherein the document library includes document titles organized according to at least one of a category, a type, and an HTML template file name.

16. An apparatus as recited in claim 12, further comprising means for allowing a user to add a new document to the document library.

17. An apparatus as recited in claim 16, wherein user authorization is required in order to allow the user to add the new document to the library.

18. An apparatus as recited in claim 12, wherein user authorization is required in order for the user to be allowed to select the document from the document library.

19. An apparatus as recited in claim 12, wherein the worksheet includes input fields for the input of variable elements of the document selected.

20. An apparatus as recited in claim 12, wherein the data from the document includes non-variable data.

21. An apparatus as recited in claim 12, wherein the data input by the user includes data input via at least one of a wireless communication device, a handheld device, a computing device, and a telephonic device.

22. An apparatus as recited in claim 12, wherein after selecting the document the user requests a corresponding worksheet.

23. A computer program embodied on a computer readable medium for providing an online document and input form creation and storage system comprising:
(a) a code segment that provides online tools enabling users to develop documents including fixed data and variable data and a worksheet relating to the variable data;
(b) a code segment that provides a library in which documents developed by the users are stored, the library being remotely accessible;
(c) a code segment that allows a particular user to select a document from the library;
(d) a code segment that provides to the particular user a worksheet corresponding to the document selected;
(e) a code segment that allows the user to input variable data into the worksheet;
(f) a code segment that merges the user input data from the worksheet with the fixed data from the document selected to develop a document file; and
(g) a code segment that utilizes the document file to display to the user a completed document including the merged data.

24. A computer program as recited in claim 23, wherein the document file including the merged data is an HTML file.

25. A computer program as recited in claim 23, further comprising a code segment that displays the completed document in a user specified format.

26. A computer program as recited in claim 23, wherein the document library includes document titles organized according to at least one of a category, a type, and an HTML template file name.

27. A computer program as recited in claim 23, further comprising a code segment that allows a user to add a new document to the document library.

28. A computer program as recited in claim 27, wherein user authorization is required in order to allow the user to add the new document to the library.

29. A computer program as recited in claim 23, wherein user authorization is required in order for the user to be allowed to select the document from the document library.

30. A computer program as recited in claim 23, wherein the worksheet includes input fields for the input of variable elements of the document selected.

31. A computer program as recited in claim 23, wherein the data from the document includes non-variable data.

32. A computer program as recited in claim 23, wherein the data input by the user includes data input via at least one of a wireless communication device, a handheld device, a computing device, and a telephonic device.

33. A computer program as recited in claim 23, wherein after selecting the document the user requests a corresponding worksheet.

34. A method for providing to users a document development system and document library storage that is remotely accessible comprising the steps of:
(a) allowing a particular user to select a document from a document library;
(b) providing to the particular user a worksheet corresponding to the document selected;
(c) allowing the user to input variable data into the worksheet;
(d) merging the user input data from the worksheet with fixed data from the document selected to develop a document file; and
(e) utilizing the document file to display to the user a completed document including the merged data.

35. A method as recited in claim 34, wherein the document file including the merged data is an HTML file.

36. A method as recited in claim 34, further comprising displaying the completed document in a user specified format.

37. A method as recited in claim 34, wherein the document library includes document titles organized according to at least one of a category, a type, and an HTML template file name.

38. A method as recited in claim 34, further comprising allowing a user to add a new document to the document library.

39. A method as recited in claim 5, wherein user authorization is required in order to allow the user to add the new document to the library.

40. A method as recited in claim 34, wherein user authorization is required in order for the user to be allowed to select the document from the document library.

41. A method as recited in claim 34, wherein the worksheet includes input fields for the input of variable elements of the document selected.

42. A method as recited in claim 34, wherein the data from the document includes non-variable data.

43. A method as recited in claim 34, wherein the data input by the user includes data input via at least one of a wireless communication device, a handheld device, a computing device, and a telephonic device.

44. A method as recited in claim 34, wherein after selecting the document the user requests a corresponding worksheet.

45. A method for providing a system for the remote development of a complete document comprising the steps of:
(a) providing online tools enabling users to develop documents including fixed data and variable data and a worksheet relating to the variable data;
(b) providing a library in which documents developed by the users are stored, the library being remotely accessible; and
(c) allowing a particular user to select a document from the library and input variable data into the worksheet corresponding to the document in order to generate a completed document.

46. A method as recited in claim 45, wherein the completed document is a display version of an HTML file.

47. A method as recited in claim 45, further comprising displaying the completed document in a user specified format.

48. A method as recited in claim 45, wherein the document library includes document titles organized according to at least one of a category, a type, and an HTML template file name.

49. A method as recited in claim 45, further comprising allowing a user to add a new document to the document library.

50. A method as recited in claim 49, wherein user authorization is required in order to allow the user to add the new document to the library.

51. A method as recited in claim 45, wherein user authorization is required in order for the user to be allowed to select the document from the document library.

52. A method as recited in claim 45, wherein the worksheet includes input fields for the input of variable elements of the document selected.

53. A method as recited in claim 45, wherein the document includes non-variable data.

54. A method as recited in claim 45, wherein the data input by the user includes data input via at least one of a wireless communication device, a handheld device, a computing device, and a telephonic device.

55. A method as recited in claim 45, wherein after selecting the document the user requests a corresponding worksheet.

56. A system for providing an online document and input form creation and storage system comprising:
a server for providing online tools for enabling users to create documents including fixed data and variable data and worksheets relating to the variable data;
a library coupled to the server for storing the documents and the worksheets developed by the users, the library being remotely accessible;
a computing device coupled to the server for a particular user to select a document from the library and input variable data into the worksheet corresponding to the document;
wherein the input variable data from the worksheet and the fixed data from the document are merged to develop a document file; and
a display medium for displaying a completed document to the particular user using the document file.
